(19) United States
(12) Patent Application Publication
(10) Pub. No.: US 2020/0189072 A1
(43) Pub. Date: Jun. 18, 2020

(54) Angle Adjustable Pliers

(71) Applicant: Heng-Yi Hsu, Tainan City (TW)

(72) Inventor: Heng-Yi Hsu, Tainan City (TW)

(21) Appl. No.: 16/802,802

(22) Filed: Feb. 27, 2020

Related U.S. Application Data
(63) Continuation-in-part of application No. 15/798,550, filed on Oct. 31, 2017.

(51) Int. Cl. B25B 7/04; B25B 7/08

(52) U.S. Cl. CPC B25B 7/04; B25B 7/08

(57) ABSTRACT

A pair of pliers include a handle unit, a head unit and at least one positioning unit. The handle unit includes two handles each having a mounting portion which is provided with a mounting slot and a regulating hole. The head unit includes two heads each provided with a working portion, a pivot hole and a plurality of positioning grooves. Each of the heads is pivotally mounted in the mounting slot by the pivot hole. Each of the positioning grooves is moved by rotation of each of the heads to align with the regulating hole. The at least one positioning unit is mounted in the regulating hole of one of the handles and locked in one of the positioning grooves of one of the heads.

### CROSS-REFERENCES TO RELATED APPLICATIONS

The present invention is a continuation-in-part (C.I.P.) application of the co-pending U.S. Ser. No. 15/798,550, filed on Oct. 31, 2017.

### BACKGROUND OF THE INVENTION

### 1. Field of the Invention

The present invention relates to a hand tool and, more particularly, to a pair of pliers for holding or fixing a part (or workpiece).

### 2. Description of the Related Art

The conventional pliers comprise two pivot members pivotally connected with each other. Each of the two pivot members has a first end provided with a working head and a second end provided with a handle. The angle between the working head and the handle of each of the two pivot members is fixed and cannot be adjusted. The conventional pliers are used to hold or fix a part so as to assemble or disassemble the part. The part has different positions so that the working head has to be inclined to a determined angle to facilitate the user operating the part. However, when the working head is inclined to the determined angle, the user cannot hold the handles exactly, thereby causing inconvenience to the user when holding the handles to operate the part.

### BRIEF SUMMARY OF THE INVENTION

The primary objective of the present invention is to provide a pair of angle adjustable pliers.

In accordance with the present invention, there is provided a pair of pliers comprising a handle unit, a head unit and at least one positioning unit. The handle unit includes two intersecting handles pivotally connected with each other. Each of the two handles has a front end provided with a mounting portion which is provided with a mounting slot. The mounting portion has a side provided with a regulating hole connected to the mounting slot. The head unit includes two heads arranged symmetrically. Each of the two heads is provided with a pivot hole spaced from the regulating hole of one of the two handles. Each of the two heads is pivotally mounted in the mounting slot of one of the two handles by the pivot hole. Each of the two heads is rotated about the pivot hole which functions as a fulcrum of each of the two heads. Each of the two heads is further provided with a plurality of positioning grooves surrounding the pivot hole. Each of the positioning grooves is moved by rotation of each of the two heads to align with the regulating hole of one of the two handles. Each of the two heads is further provided with a working portion. The at least one positioning unit is mounted in the regulating hole of one of the two handles and locked in one of the positioning grooves of one of the two heads.

According to the primary advantage of the present invention, the angle and direction of the working portion of each of the two heads can be changed easily and quickly to facilitate the user operating the pliers.

Further benefits and advantages of the present invention will become apparent after a careful reading of the detailed description with appropriate reference to the accompanying drawings.

### BRIEF DESCRIPTION OF THE SEVERAL VIEWS OF THE DRAWING(S)

FIG. 1 is an exploded perspective view of a pair of pliers in accordance with the preferred embodiment of the present invention.

FIG. 2 is a partially cross-sectional assembly view of the pliers in accordance with the preferred embodiment of the present invention.

FIG. 3 is a partially planar assembly view of the pliers in accordance with the preferred embodiment of the present invention.

FIG. 4 is a schematic operational view of the pliers as shown in FIG. 3 in adjustment.

FIG. 5 is a schematic view showing one of the two heads of the pliers rests on the restriction portion.

### DETAILED DESCRIPTION OF THE INVENTION

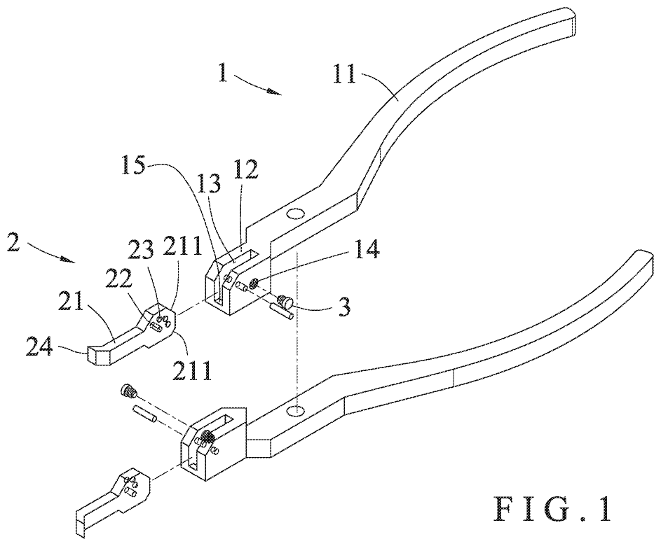

Referring to the drawings and initially to FIGS. 1-3, a pair of pliers in accordance with the preferred embodiment of the present invention comprise a handle unit 1, a head unit 2 and at least one positioning unit 3.

The handle unit 1 includes two intersecting handles 11 pivotally connected with each other. The two handles 11 are pivoted about a pivot point, and pivoting of the two handles 11 is conventional and will not be further described in detail. Each of the two handles 11 has a front end provided with a mounting portion 12 which is provided with a mounting slot 13. The mounting portion 12 has a side provided with a regulating hole 14 connected to the mounting slot 13.

The head unit 2 includes two heads 21 arranged symmetrically. Each of the two heads 21 is provided with a pivot hole 22 spaced from the regulating hole 14 of one of the two handles 11. Each of the two heads 21 is pivotally mounted in the mounting slot 13 of one of the two handles 11 by the pivot hole 22. Each of the two heads 21 is rotated about the pivot hole 22 which functions as a fulcrum of each of the two heads 21. Each of the two heads 21 is further provided with a plurality of positioning grooves 23 surrounding the pivot hole 22. Each of the positioning grooves 23 is moved by rotation of each of the two heads 21 to align with the regulating hole 14 of one of the two handles 11. Each of the two heads 21 is further provided with a working portion (or tool portion) 24.

The at least one positioning unit 3 is mounted in the regulating hole 14 of one of the two handles 11 and locked in one of the positioning grooves 23 of one of the two heads 21.

In the preferred embodiment of the present invention, the at least one positioning unit 3 includes a regulating member 31 having an interior provided with a recess 312, a positioning member 33 mounted in the recess 312 of the regulating member 31 and locked in one of the positioning grooves 23, and an elastic member 32 mounted in the recess 312 of the regulating member 31 and biased between the regulating member 31 and the positioning member 33. The at least one positioning unit 3 adopts a modularized design, that is, the elastic member 32 and the positioning member 33 are assembled into the regulating member 31 previously, and the regulating member 31 is then assembled into the regulating hole 14, thereby saving the time of assembly.

In the preferred embodiment of the present invention, the regulating hole 14 of each of the two handles 11 is a screw hole, and the regulating member 31 of the at least one positioning unit 3 is provided with an external thread 311 screwed into the regulating hole 14.

In the preferred embodiment of the present invention, each of the two heads 21 has a periphery provided with a plurality of chamfered faces 211 to facilitate rotation of each of the two heads 21. The mounting slot 13 of each of the two handles 11 has an interior formed with a restriction portion 15. One of the chamfered faces 211 is moved to abut the restriction portion 15 when each of the two heads 21 is rotated to a predetermined angle, to stop rotation of each of the two heads 21.

In the preferred embodiment of the present invention, the working portion 24 of each of the two heads 21 has a hook shape.

In the preferred embodiment of the present invention, the positioning member 33 of the at least one positioning unit 3 has a spherical shape.

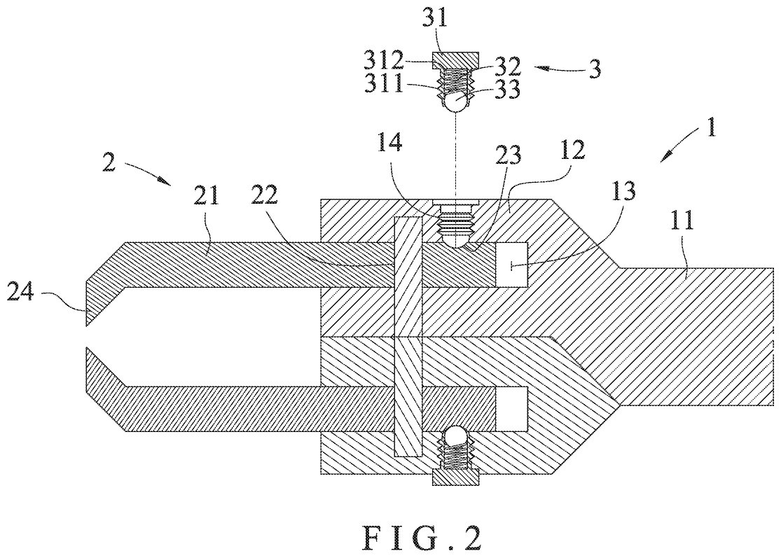

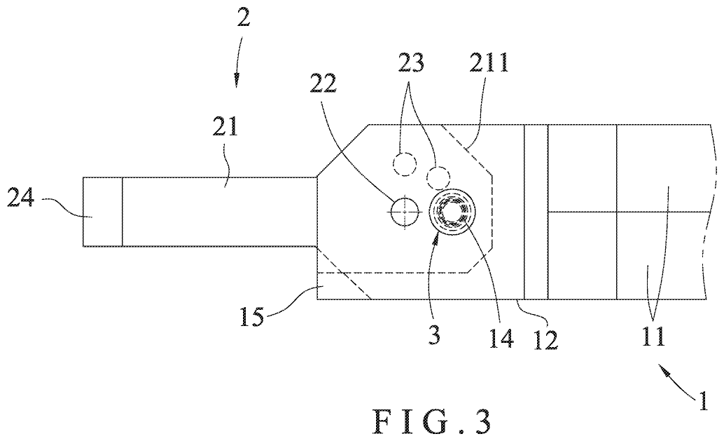

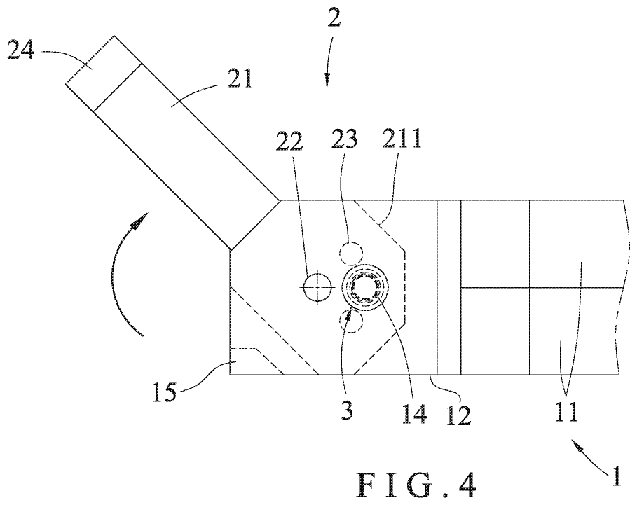

In operation, referring to FIGS. 3 and 4 with reference to FIGS. 1 and 2, each of the positioning grooves 23 is moved by rotation of each of the two heads 21 to align with the regulating hole 14, so that the positioning member 33 is locked in one of the positioning grooves 23, so as to locate the angle of the working portion 24. When one of the two heads 21 is driven to pivot about the pivot hole 22, the positioning member 33 is detached from one of the positioning grooves 23 and is retracted into the recess 312 of the regulating member 31, and the elastic member 32 is compressed by the positioning member 33 to store a restoring force. When another one of the positioning grooves 23 is moved to align with the regulating hole 14, the positioning member 33 is locked in another one of the positioning grooves 23, so as to locate the angle of the working portion 24. Thus, the angle of the working portion 24 is changed as shown in FIGS. 3 and 4.

It is appreciated that, the regulating member 31 is provided with an external thread 311 screwed into the regulating hole 14, so that when the regulating member 31 is rotated, the regulating member 31 is moved in the regulating hole 14 to bias the elastic member 32, so as to regulate the tension of the elastic member 32.

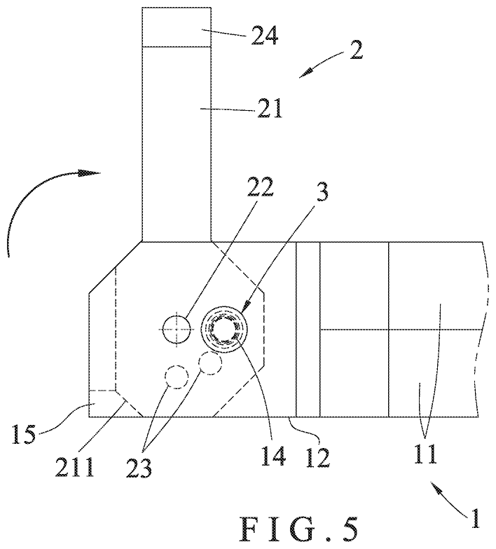

Accordingly, the angle and direction of the working portion 24 of each of the two heads 21 can be changed easily and quickly to facilitate the user operating the pliers. In addition, each of the two heads 21 rests on the restriction portion 15 as shown in FIG. 5. At this time, when the working portions 24 clamp a workpiece to be pulled, each of the two heads 21 is restricted and positioned and cannot be rotated, to facilitate the user applying a force to pull the workpiece that is hard to be pulled.

Although the invention has been explained in relation to its preferred embodiment(s) as mentioned above, it is to be understood that many other possible modifications and variations can be made without departing from the scope of the present invention. It is, therefore, contemplated that the appended claim or claims will cover such modifications and variations that fall within the scope of the invention.

1. A pair of pliers comprising:
a handle unit, a head unit and at least one positioning unit;
wherein:
the handle unit includes two intersecting handles pivotally connected with each other;
each of the two handles has a front end provided with a mounting portion which is provided with a mounting slot;
the mounting portion has a side provided with a regulating hole connected to the mounting slot and the regulating hole is a screw hole;
the head unit includes two heads arranged symmetrically;
each of the two heads is provided with a pivot hole spaced from the regulating hole of one of the two handles;
each of the two heads is pivotally mounted in the mounting slot of one of the two handles by the pivot hole;
each of the two heads is rotated about the pivot hole which functions as a fulcrum of each of the two heads;
each of the two heads is further provided with a plurality of positioning grooves;
each of the positioning grooves is moved by rotation of each of the two heads to align with the regulating hole of one of the two handles;
the mounting slot of each of the two handles has an interior formed with a restriction portion;
each of the two heads has a periphery provided with a plurality of chamfered faces;
one of the chamfered faces is moved to abut the restriction portion when each of the two heads is rotated to a predetermined angle, to stop rotation of each of the two heads;
each of the two heads is further provided with a working portion having a hook shape; and
the at least one positioning unit includes a regulating member provided with an external thread screwed into the regulating hole;
each of the regulating member further having an interior provided with a recess, a positioning member mounted in the recess of the regulating member and locked in one of the positioning grooves of one of the two heads, and an elastic member mounted in the recess of the regulating member and biased between the regulating member and the positioning member.

2. The pliers of claim 1, wherein the positioning member has a spherical shape.
